(19) United States
(12) Patent Application Publication
(10) Pub. No.: US 2010/0161793 A1
(43) Pub. Date: Jun. 24, 2010

(54) METHOD FOR COMPOSING ON-CHIP NETWORK TOPOLOGY

(75) Inventors: Bae Young Hwan, Daejeon (KR); Cho Han-Jin, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/511,278

(22) Filed: Jul. 29, 2009

(30) Foreign Application Priority Data
Dec. 18, 2008 (KR) 10-2008-0129164

(51) Int. Cl. G06F 15/16

(52) U.S. Cl. 709/224

(57) ABSTRACT

A method for optimizing a binary tree includes: sequentially searching a binary tree having IP modules of an on-chip network as the lowermost child nodes in a direction from the lowermost node to the uppermost node, and checking whether or not a search target node has child nodes; if the search target node does not have a child node, directly obtaining a minimum solution of the search target node, while if the search target node has child nodes, obtaining the minimum solution of the search target node by using the minimum solutions of the child nodes; and if the search target node is an intermediate node, continuously searching the binary tree, and if the search target node is a root node, optimizing the binary tree by merging nodes of the binary tree according to the minimum solution.

### CROSS-REFERENCE TO RELATED APPLICATIONS

This application claims the priority of Korean Patent Application No. 2008-129164 filed on Dec. 18, 2008, in the Korean Intellectual Property Office, the disclosure of which is incorporated herein by reference.

### BACKGROUND OF THE INVENTION

1. Field of the Invention

The present application relates to a technique for designing a system on chip (SoC) and, more particularly, to a method of composing an on-chip network topology capable of effectively performing a binary tree optimization process to generate an on-chip network topology.

2. Description of the Related Art

Currently, in a platform-based design scheme commonly used for designing a system on chip (SoC), a communications structure, along with a processor, are key design factors.

As the number of transistors integrated on the SoC grows in geometrical progression, communications traffic between configuration modules, i.e., cores, tends to rapidly increase, making it difficult to design the communication structure.

An SoC bus, such as an advanced micro-controller bus architecture (AMBA) commonly used as a communications structure for current SoCs, has a structure in which different communications subjects share limited communications mediums by way of time-division. Thus, problems such as restrictions of design expandability, limitations in performance, and rapid increases in power consumption arise as the result of increases in communications requests.

The restrictions of the SoC bus bring about severe design restrictions in applications for use in fields such as the multimedia application field, in which a huge amount of data must be transmitted and received in real time.

Thus, an on-chip network, adapting a computer network technique to an on-chip, has been proposed as an alternative to solve the above problems.

The on-chip network enables modularization, has good expandability potential, and allows various IP modules to be easily connected, and as such it has received a lot of attention as a next-generation SoC communication structure.

On-chip networks are being researched in some prestigious international universities, but a commercialized technique is yet to be developed. A design automation tool for automatically composing SoC network-based communication structures optimized for each design is called an on-chip network compiler. Research into an on-chip network compiler is actively ongoing and Stanford University's Xpipes on-chip network compiler is a typical example.

The Xpipes complier supports on-chip networks of various topologies and outputs SystemC codes as a result of its compositions. However, in spite of supporting various network topologies, the Xpipes compiler uses simple mapping to predetermined topologies, without the ability of generating an optimum on-chip network for each design. In addition, because the Xpipes complier does not consider communications time duration between IP modules and corresponding power consumption, its composing results may be somewhat irrational in many cases.

In actuality, in order to compose an optimum on-chip network topology satisfying a designing purpose, the network topology must be composed to enable communications using the least amount of hardware, the lowest levels of power consumption, and operate within the shortest periods of time by recognizing communications patterns between IP modules to be connected to a network.

In case of an application design-dedicated SoC embedded in a moving picture experts group 4 (MPEG4) and high definition television (HDTV) system, it includes multiple function blocks. Because communications patterns between the function blocks have consistency according to application fields, they can be predictable at the early stage of design.

In order to design an optimum communications structure in terms of chip area, performance, and power consumption, a design-specialized on-chip network optimized for the communications patterns of each design is advantageous, compared with the conventional typical topology type on-chip network with a regular structure.

The design-specialized on-chip network is designed such that negative factors affecting performance, such as an average communication latency, chip area, and the like, are minimized by analyzing communications patterns between the configuration modules.

The existing IP modules commonly used for current SoC designing are designed to satisfy the conventional communications structure, and overall communications may be started by only a small number of master modules such as a processor, a direct memory access controller (DMAC), and the like. Server modules such as a memory and the like simply provide services for transactions requested by the master modules.

In case of modules which frequently request communications from each other, they need to be positioned to be close to each other in the network topology to shorten communications time and minimize the amount of communications traffic that passes through the network. If they are designed such that a huge amount of data passes through a long path in the network, they would occupy network communications resources such as a communications buffer, a crossbar switch, a communication link, and the like. In that case, communications between the other modules would be interfered with, degrading the overall communications performance and causing unnecessary energy consumption.

Thus, the development of a designing methodology allowing the design of a topology such that function blocks requesting a large amount of communications are disposed to be close to one another in the network is significant in the topology determining stage during the initial design stage.

### SUMMARY OF THE INVENTION

An aspect of the present application provides a method for composing an on-chip network topology capable of disposing function blocks requesting a large amount of communication such that they are close to each other in a topology determining stage to thus minimize the communications energy consumption of the system on-chip.

Another aspect of the present application provides a method of composing an on-chip network topology capable of effectively performing a binary tree optimization process to determine an on-chip network topology.

According to an aspect of the present application, there is provided a method of composing an on-chip network topology, including: analyzing a communications pattern between IP modules and generate a traffic graph by performing SoC designing specification-implemented reference codes and generating a traffic graph; generating a binary tree having the IP modules as the lowermost child nodes based on the traffic graph; obtaining a minimum solution of each node while sequentially searching the binary tree in a direction from the lowermost nodes to the uppermost node, and if a search target node has child nodes, obtaining a minimum solution of the search target node by using the minimum solutions of the child nodes; if the search target node is a root node, stopping the searching of the binary tree and merging the nodes of the binary tree according to the minimum solution of the search target node; inserting an additional path for shortening a communication time between nodes into the binary tree to optimize the binary tree; and generating hardware having the optimized binary tree as an on-chip topology.

The obtaining of the minimum solution of the search target node may include: sequentially searching the binary tree in the direction from the lowermost node to the uppermost node and checking whether or not the search target node has child nodes; if the search target node does not have a child node, directly obtaining the minimum solution of the search target node; and if the search target node has child nodes, obtaining the minimum solution of the search target node by using the minimum solutions of the child nodes.

The directly obtaining of the minimum solution of the search target node may include: obtaining a solution set by applying all kinds of covering patterns, and obtaining a solution with the lowest cost in the solution set, as the minimum solution of the search target node.

The obtaining of the minimum solution of the search target node by using the minimum solutions of the child nodes may include: merging the minimum solutions respectively obtained by the child nodes into the search target node while distributing the maximum number (K) of edges connectable to the search target node, as h (1≦h<K−1) and K−h, to the child nodes, to obtain the minimum solution of the search target node.

According to another aspect of the present application, there is provided a method for optimizing a binary tree, including: sequentially searching a binary tree having IP modules of an on-chip network as the lowermost child nodes in a direction from the lowermost node to the uppermost node, and checking whether or not a search target node has child nodes; if the search target node does not have a child node, directly obtaining a minimum solution of the search target node, and if the search target node has child nodes, obtaining the minimum solution of the search target node by using the minimum solutions of the child nodes; and if the search target node is an intermediate node, continuously searching the binary tree, and if the search target node is a root node, optimizing the binary tree by merging nodes of the binary tree according to the minimum solution.

The obtaining of the minimum solution of the search target node may include: if the search target node has no child node, obtaining the minimum solution of the search target node by applying all kinds of covering patterns; and if the search target node has child nodes, merging the minimum solutions respectively obtained by the child nodes into the search target node while distributing the maximum number (K) of edges connectable to the search target node, as h (1≦h<K−1) and K−h, to the child nodes, to obtain the minimum solution of the search target node.

### BRIEF DESCRIPTION OF THE DRAWINGS

The above and other aspects, features and other advantages of the present application will be more clearly understood from the following detailed description taken in conjunction with the accompanying drawings, in which:

FIG. 1 is a flow chart illustrating the operation of a method of composing an on-chip network topology according to an exemplary embodiment of the present application;

FIG. 2 illustrates a traffic graph according to an exemplary embodiment of the present application;

FIG. 3 illustrates a binary tree configured based on the traffic graph of FIG. 2;

FIG. 4 illustrates merging of nodes of the binary tree having K=4;

FIG. 5 illustrates a tree structure optimized through node merging of FIG. 4;

FIGS. 6a to 6c illustrate various covering patterns with respect to a search target node (n6);

FIGS. 7a to 7c illustrate coverage according to the covering patterns (P6) of the search target node (n6);

FIG. 8 illustrates a process of obtaining a solution of min-cover (n6, 4) of the node (n6) by using the case that K is distributed as (1,3);

FIG. 9 illustrates a solution of min_cover (n6, 4) of the node (n6);

FIG. 10 illustrates a tree optimization algorithm using a dynamic programming method according to an exemplary embodiment of the present application; and

FIGS. 11a to 11c illustrate a process of searching critical paths and inserting a communication path therebetween according to a performance optimization process using a Greedy algorithm according to an exemplary embodiment of the present application.

### DETAILED DESCRIPTION OF THE PREFERRED EMBODIMENT

Exemplary embodiments of the present application will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

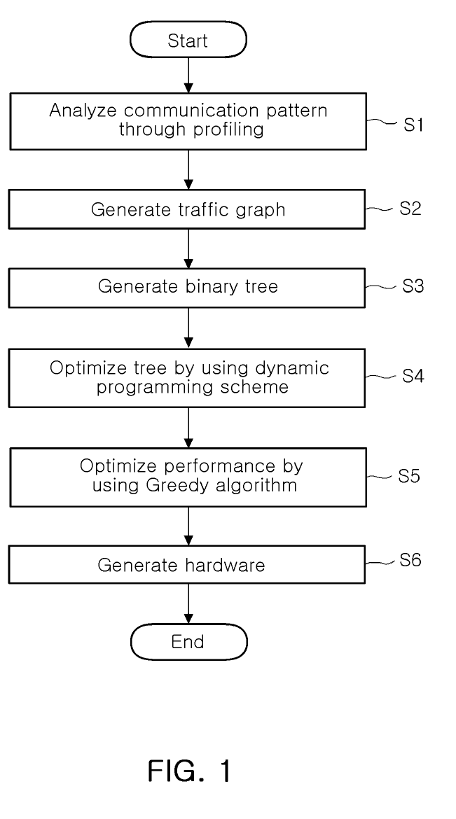

FIG. 1 is a flow chart illustrating the operation of a method of composing an on-chip network topology according to an exemplary embodiment of the present application.

The method of composing an on-chip network topology includes: performing a reference code of a system on chip (SoC) design specification implemented as a C language or a SystemC language to analyze a communications pattern between IP modules in an actual performing environment (S1); generating a traffic graph based on the communications pattern of each of cores (S2); generating a binary tree by setting the cores as the lowermost child nodes and then grouping pairs of nodes performing frequent communications in a bottom-up manner based on the traffic graph (S3); obtaining a minimum solution of each node while sequentially searching the binary tree in a direction from the lowermost nodes to the uppermost node to minimize delay time and the area between nodes and merging the nodes of the binary tree based on the minimum solutions, and, in this case, if a search target node (i.e., node to be searched) has child nodes, obtaining a minimum solution of the search target node by using minimum solutions of the child nodes and merging the nodes of the binary tree according to the minimum solution to optimize the binary tree (S4); inserting an additional path for shortening a communication time between nodes into the binary tree through a Greedy algorithm (S5); and generating hardware having the optimized binary tree as an on-chip topology (S6).

Each step will now be described in detail.

(1) Analyzing Communications Pattern Between IPmodules Step (S1).

A reference code of design specification of an SoC, which a designer desires to fabricate generated in a C or SystemC code format, is performed to analyze a communications pattern (i.e., a communications request direction and the amount of communications) between IP modules (e.g., a processor, a DMAC, a memory, etc.) in an actual performing environment.

(2) Generating Traffic Graph Step (S2).

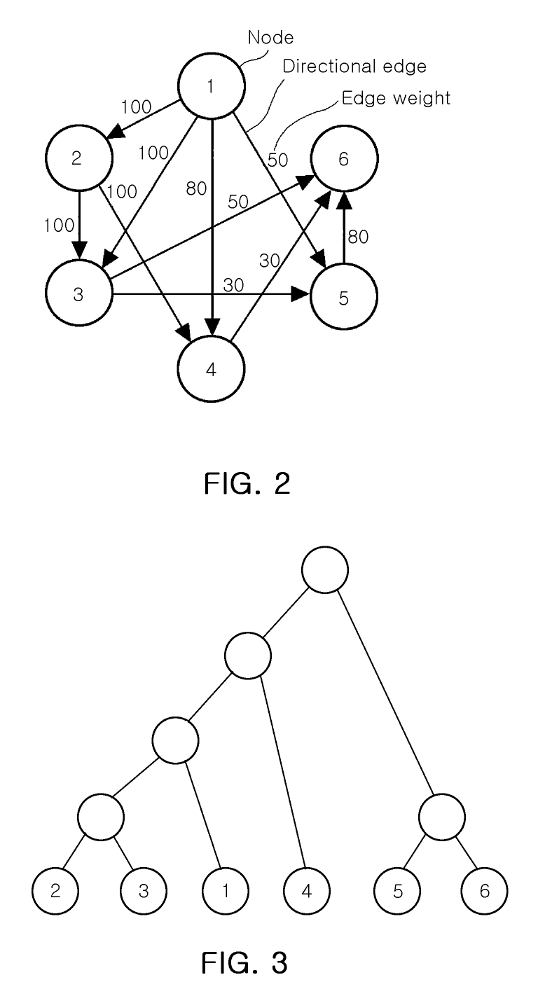

A traffic graph, as shown in FIG. 2, is generated based on the communications pattern between the IP modules recognized in the communications pattern analysis step (S1). The traffic graph is expressed as a directional graph as shown in FIG. 2, including directional edges indicating a communications request direction between nodes and edge weights indicating the amount of communications between nodes.

(3) Generating Binary Tree Step (S3).

In order to minimize the occurrence of unnecessary traffic in an on-chip network, the network topology must be designed such that communication packets move the minimum possible distance. The distance between communications modules directly affects communications delay times, so the IP modules performing frequent communication with each other on the traffic graph must be connected to the same crossbar switch or allocated to a nearby crossbar switch in the network.

Thus, in an exemplary embodiment of the present application, a binary tree having minimum delay time is configured by setting nodes corresponding to the IP modules as the lowermost child nodes, and then grouping pairs of nodes performing frequent communication therebetween in a bottom-up manner based on the traffic graph.

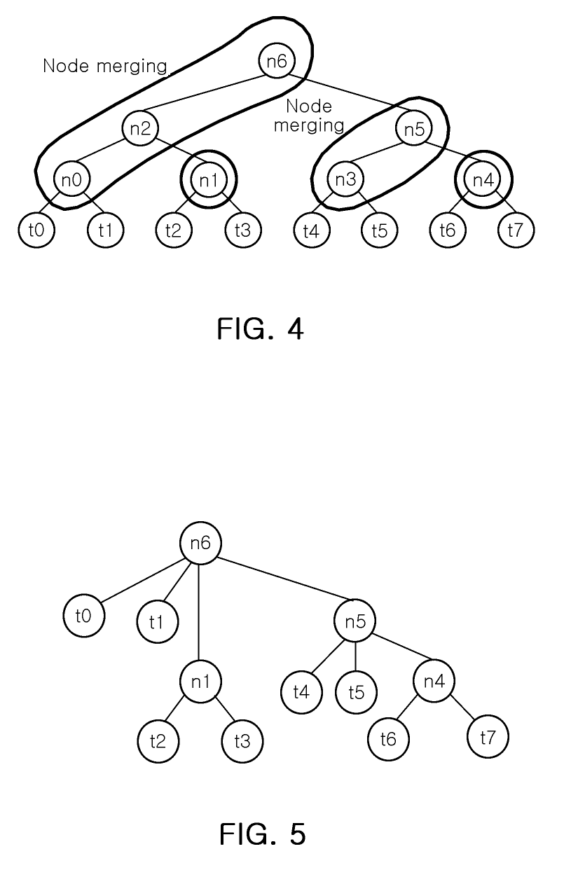

FIG. 3 illustrates a binary tree configured based on the traffic graph of FIG. 2. The binary tree configured thusly is called a topology graph.

The topology graph (N (V, E)) is a non-directional graph in which a vertex (vᵢ ∈ V) means one node (i.e., an IP module or a crossbar switch) in the network, and an inter-node edge (vᵢ, vⱼ) represented by ‘e_{i,j} ∈ E’ indicates a communication link between a node (vᵢ) and a node (vⱼ), and the weight (w_{i,j′}) of each edge (e_{i,j}) means the number of links.

In the minimum delay time binary tree, because only a single shortest communication path exists between two nodes, the amount of communication traffic passing through each edge on the topology can be obtained. One or more communication links may be allocated between two nodes that require larger communication traffic than that of a bandwidth accommodated by a single communication link. In this case, the number of required communication links is represented by a weight of a corresponding edge on the topology, and the weight (w_{i,j′}) of the edge is calculated by Equation 1 shown below:

w_{i,j}=┌|T_{i,j}|/(BWoL)┐ [Equation 1]

In Equation 1, BWoL is a bandwidth of a corresponding communication link, and T_{i,j} is the total amount of communications traffic that must pass through a corresponding edge.

The set (V) of vertexes on the topology graph include a set (Vc) of core nodes and a set (Vs) of switch nodes which have a relationship of ‘V=Vc ∪Vs’ and ‘Vc ∩ Vs=0’.

A core node is a node corresponding to an IP module such as a processor, a DMAC, a memory, or the like. That is, the core node refers to one of the network's terminal nodes. The switch node refers to a node corresponding to a crossbar switch for communication.

(4) Merging Binary Tree Nodes Using Dynamic Programming Scheme Step (S4).

When each switch node of the binary tree is implemented as a 3-port crossbar switch in a 2×1 form, core nodes connected via several crossbar switches in the network must pass many switches amid a communications channel, lengthening communications delay time.

In general, a hardware library provides a maximum K-port crossbar switch (K is generally 8 to 16) as well as the 3-port crossbar switch. Thus, preferably, the network needs to be designed such that a hardware area and a level of overall network power consumption are minimized and its performance is maximized by utilizing the crossbar switches of various sizes provided by the hardware library to its maximum level.

To this end, an optimization process is performed to merge several switch nodes to extend the topology graph in the binary tree form in which the nodes have a node degree of 3 up to a maximum, K. Here, the node degree refers to the number of edges connected to a single vertex.

Such a node merging process is a process of attempting to merge the switch nodes to nearby switch nodes in every possible form on the topology graph and finding a solution having a minimum area, maximum performance, and minimum power consumption.

A pattern allowing a node to be merged with several nearby nodes until the node degree is the maximum K is defined as a covering pattern. The purpose of using the covering pattern is to generate sets of candidates that can be merged with several nearby neighboring nodes based on one node.

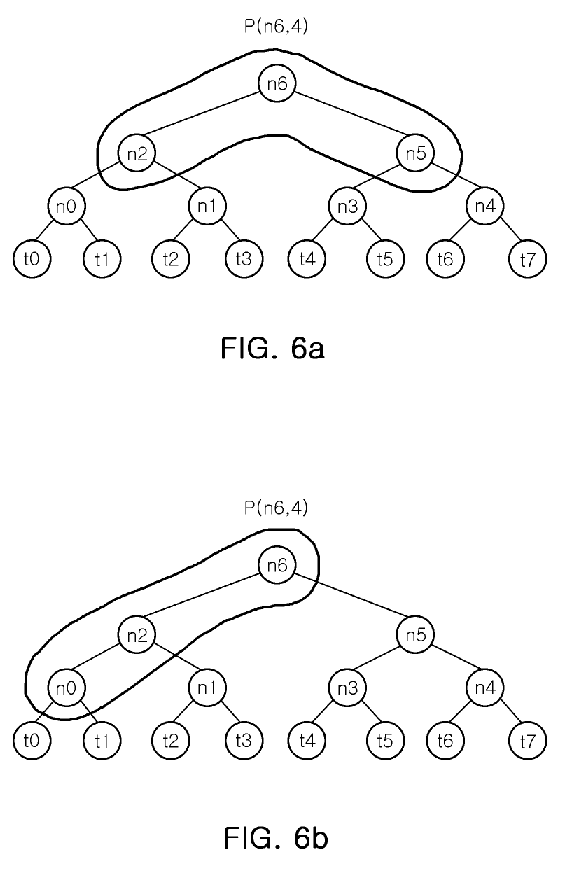

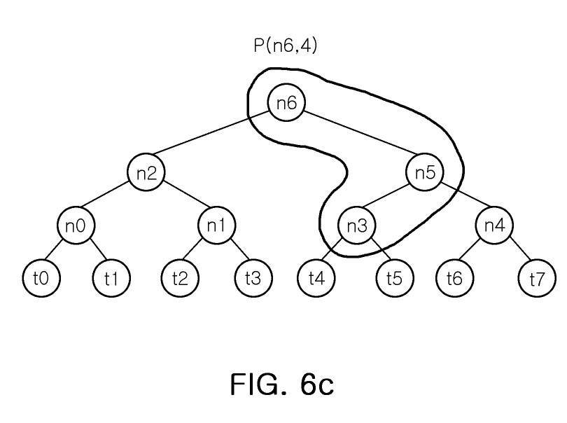

In the optimization process, various covering patterns are applied to the entire binary tree to calculate their costs and find a solution among them having a minimum cost. When the node merging topology optimization is performed, the binary tree is changed to a tree having the maximum node edge number of K as shown in FIG. 5 through the node merging process as shown in FIG. 4.

$${C}_{comm} = {\sum }_{∀ i , j ∈ Nc} latency ( i , j ) \times \vert {T}_{i , j} \vert , \\ {C}_{area} = {\sum }_{∀ n ∈ Ns} area ( n ) , \\ {C}_{total } = α \cdot {C}_{area} + β \cdot {C}_{comm} \qquad [ Equation 2 ]$$

In Equation 2, T_{i,j} is the sum of a total amount of communication traffic between the core nodes i and j, latency (i, j) is the distance between the core nodes i and j on the topology, area(n) is a normalized hardware area of the switch node (n), and α and β are constant values for adjusting balance between an experimentally determined area cost and a communication time cost.

A covering pattern (P(n,h)) of an edge degree (h) (2≦h≦K) with respect to the switch node (n ∈ Vs) is a set of nodes constituting a sub-tree including the node (n) as a root node, which is a set of nodes for which the sum of edges connected from the P(n,h) to the exterior is ‘h’.

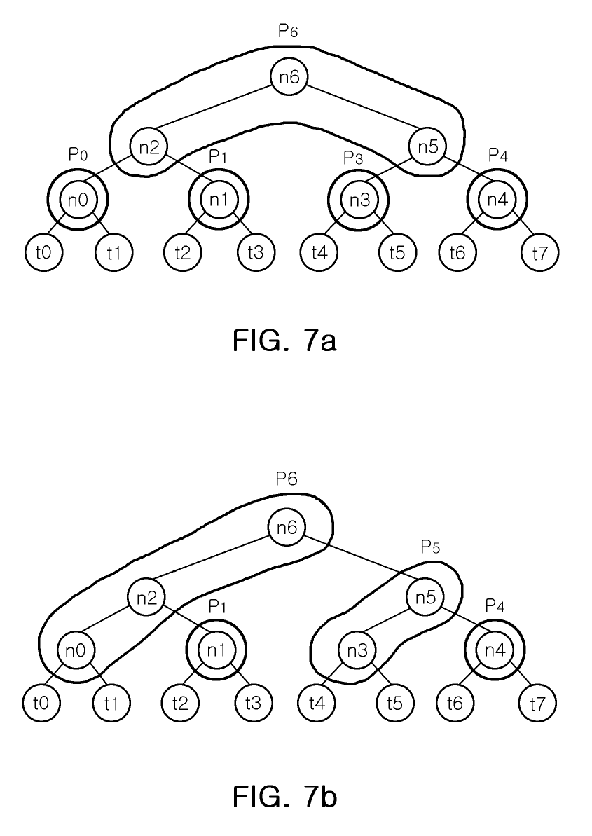

FIGS. 6a to 6c illustrate various covering patterns P(n6, 4) with respect to a node (n6). The nodes n2, n5, and n6 included in the covering pattern P(n6, 4) may be merged into a single node in the optimization process so as to be implemented as a single crossbar switch with a port number 4.

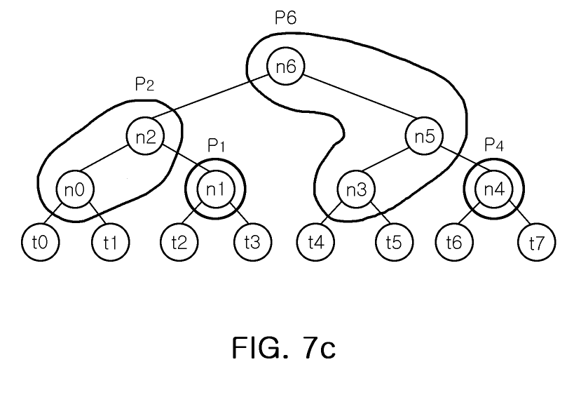

As shown in FIGS. 7A to 7C, when the nodes in the overall binary tree are included in sets of covering patterns that do not overlap with each other, the covering patterns are defined as a single cover. Namely, a single cover refers to a single node merging solution in the optimization process.

The cover (Cₖ) with respect to the topology graph S(N, L), which is a set of covering patterns (Pᵢ), satisfies the following conditions as represented by Equation (3) shown below:

$${⋃}_{1 \leq i \leq \vert P \vert} {P}_{i} = Vs , and {⋂}_{1 \leq i \leq \vert P \vert} {P}_{i} = φ . \qquad [ Equation 3 ]$$

Namely, a set of covering patterns including all the nodes but not in an overlap manner in the single tree is defined as a cover. Because the covering patterns are diverse, covers covering a single binary tree by combining the diverse covering patterns would be numerous.

Min_cover refers to a cover having a minimum solution among diverse covers. Namely, min_cover (n, K) refers to a cover having a minimum cost function value among various covers when the maximum connectable edge number is K.

In FIGS. 7a to 7c, terminal nodes t0 to t7 are core nodes connected to the network, and the other remaining nodes n0 to n6 are switch nodes.

FIG. 7a shows ‘Ck’, an example of a cover of the node n6 (Ck={P6, P0, P1, P3, P4}). P6, a covering pattern of n6, includes nodes n2 and n5 (P6=P(n6, 4)={n2, n5}. FIGS. 7b and 7c show another covers.

Among the various expressed covers, a cover having a minimum cost function Cₜₒₜₐₗ is min-cover (n6, 4) having a minimum cost solution. For example, in cover C={P0, P1, P3, P4} of FIG. 7b, if the cost value is minimum, the cover becomes min_cover (n6, 4) having a minimum solution of the node n6.

However, in the binary tree, the number of covering patterns with respect to a single node grows in geometrical progression according to the K value, the maximum number of edges that can be connected to the corresponding node. As shown in Table 1, if K is larger than 12, the number of covering patterns exceeds 58,786.

If the number of switch nodes in the binary tree is N, the number of covers of the tree is N×Covering_Pattern_Size, and in order to obtain min_cover, covers of every number of cases should be obtained to find a cover having a minimum cost.

However, in a general case (K>12, N>10), searching every number of cases and obtaining a minimum solution seems impossible to be calculated in a real time.

TABLE 1

| | K | | | | | | | | | | |
|---|---|---|---|---|---|---|---|---|---|---|---|
| | 1 | 2 | 3 | 4 | 5 | 6 | 7 | 8 | 9 | 10 | 11 |
| Covering | 1 | 2 | 5 | 14 | 42 | 132 | 429 | 1,430 | 4,862 | 16,796 | 16,796 |
| patterns | | | | | | | | | | | |

Thus, the present application proposes a new type of optimization method using a dynamic programming scheme. The dynamic programming scheme is an optimization method using a divide-and-conquer method allowing a minimum solution to be obtained within the minimum possible time.

To this end, in an exemplary embodiment of the present application, first, the binary tree is searched in the direction from the lowermost node to the uppermost node in a depth-first manner to determine a search target node.

When a search target node is determined, it is checked whether or not the search target node has child nodes. If the search target node does not have a child node, a min_cover having a minimum solution is obtained by applying all the available covering patterns to the search target node likewise as in the related art.

If, however, the search target node has child nodes, a min_cover of the search target node by utilizing a previously obtained min_cover of the child nodes and solutions of the child nodes without any additional recalculation.

Thus, in the exemplary embodiment of the present application in order to obtain the min_cover having a minimum solution with respect to a sub tree, a portion of the entire tree, the solutions which have been already calculated for sub trees introduced to a given covering pattern are required.

In this case, however, because the optimization process is performed in the depth-first manner, all the partial solutions with respect to the sub trees have been already calculated. Thus, in case that the covering pattern is applied to the search target node (n) having the child nodes, the minimum value is not calculated by applying the covering patterns of every case but the previously calculated solutions of the two child nodes are utilized.

Namely, when the search target node (n) has two child nodes (n→left_son, n→right_son), for the min_cover (n, K) with respect to the search target node, each minimum cost cover for K distributed as h and K-h and a minimum solution having a minimum cost among solutions obtained by merging the search target node (n) may be obtained for each of the two child nodes (n→left_son, n→right_son).

This is defined by Equation 4 shown below:

min_cover(n, K)=Min(h∀(1≦h≦K−1),

merge(n, min_cover(n→left_son,h), min_cover(n→right_son, K−h)) [Equation 4]

In Equation 4, min_cover(n→left_son,h) is a cover in which the left child node has a minimum solution, and min_cover(n→right_son, K−h) is a cover in which the right child node has a minimum solution.

By performing this process on the entire binary tree, the root node may finally obtain a min_cover (root, K), a minimum solution of the entire tree.

Table 2 below shows the number of cases of h distributed to the two child nodes when K is 4. The searching process of min_cover of the search target node (n) is performed on the every number of cases as shown in Table 2.

TABLE 2

K = 4

| | Left | Right |
|---|---|---|
| h | 1 | 3 |
| | 2 | 2 |
| | 3 | 1 |

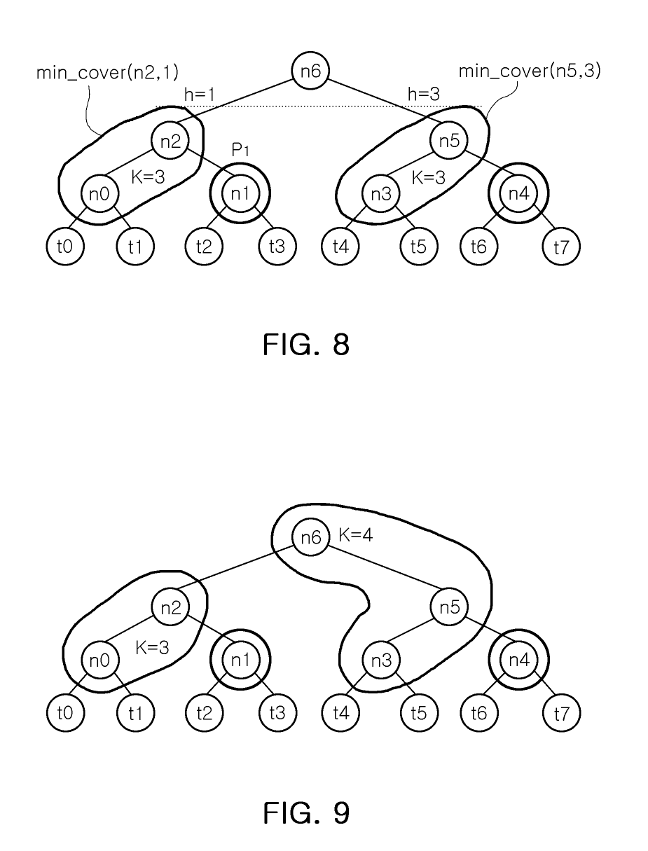

FIG. 8 illustrates a process of obtaining a solution of min_cover (n6, 4) of the node (n6) by using the case that K is distributed as (1,3).

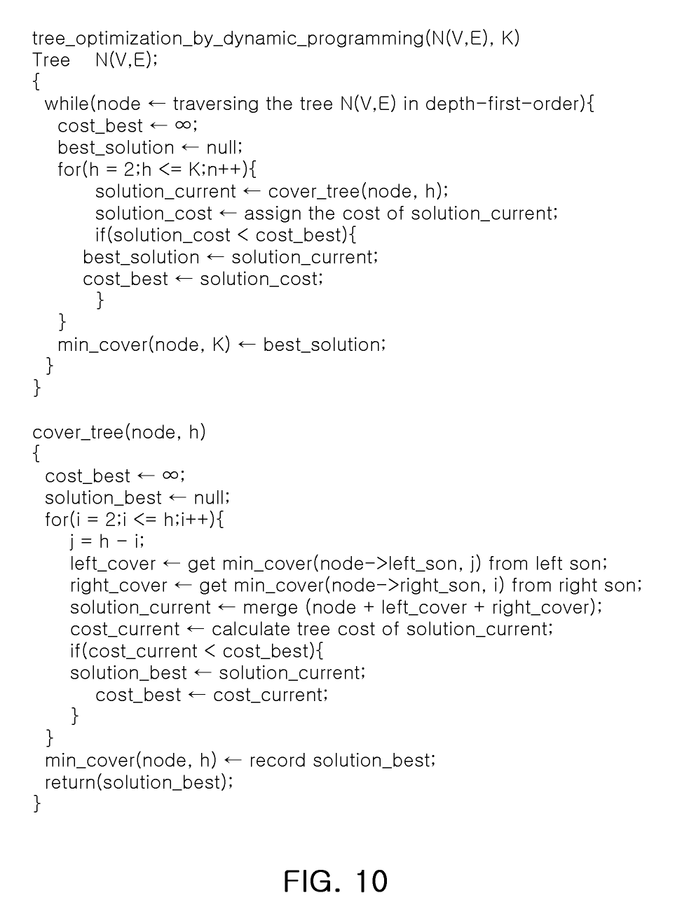

As shown in FIG. 8, when K is distributed as 1 and 3 to the two child nodes (n2, n5) of the search target node (n6), two covers of min_cover (n2, 1) of the left child node (n2) and min_cover (n5, 3) of the right child node (n5) are merged into the current root node (n6) to obtain a solution of min_cover (n6, 4) as shown in FIG. 9.

In this manner, solutions of min_cover (n6, 4) are obtained over the every number of cases of K distribution, and among them, a solution having a minimum cost is searched (found) and stored as the minimum solution of min_cover (n6, 4).

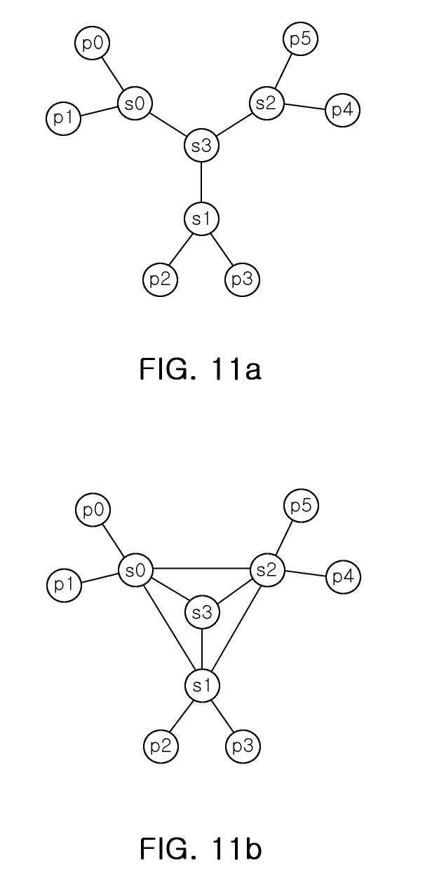

FIG. 10 illustrates a tree optimization algorithm using the above-described dynamic programming method. The binary tree generated through step S3 is optimized through the tree optimization algorithm coded as shown in FIG. 10 into an on-chip network topology graph of a minimum area with a maximum node edge number of K and a minimum delay time.

(5) Optimizing Performance of On-Chip Network Topology Through Greedy Algorithm Step (S5).

In a state that the communications delay times between core nodes and the chip area are minimized in the former step, the topology of the tree structure is altered to a general graph structure and optimization process is performed to further reduce the communication delay time.

Namely, in order to better overall network performance, a direction communication link is allocated to the detour paths between the switch nodes that are returned after passing through several nodes due to the characteristics of the tree structure. In this case, although the overall chip area increases, the overall communication path delay time can be shortened through the insertion of a short-cut path.

The performance optimization process using the Greedy algorithm is performed within a range in which the overall area does not exceed a predetermined limit. That is, a pair of switch nodes having the largest amount of communication (i.e., that communicate with each other most frequently) are selected, between which a direct communication link is connected, and if the sum of areas does not exceed the predetermined limit while an overall communication delay time is reduced, the direct communication link is employed, or otherwise, the added path is removed. This process is repeatedly performed.

The Greedy optimization is performed until such time as there are no more critical paths or until such time as the improvement of communication delay time is not expected any longer.

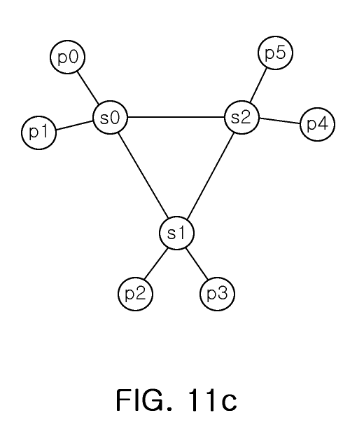

FIGS. 11a to 11c illustrate a process of searching critical paths and inserting a communications path therebetween according to the performance optimization process using the Greedy algorithm.

When the topology of the tree structure represented as shown in FIG. 11a is input, the Greedy algorithm inserts a direct path between switch nodes to convert the topology of the tree structure into a graph structure as shown in FIG. 11b. Whether or not there is an unnecessary switch node on the topology is checked during each optimization process, the shortest path of every communication request is obtained, and an unnecessary node such as node s3 or link is removed to finally generate an optimized topology as shown in FIG. 11c.

(6) Making the On-Chip Network Topology Hardware Step (S6).

The on-chip network topology optimized through the above process is finally output in the form of SystemC. The generated on-chip network is connected to IP modules in a SystemC-based design environment to verify its function and performance.

When the function and performance of the on-chip network are successfully verified, the on-chip network is finally implemented as hardware in the form of ASIC (Application Specific Integrated Circuit) or FPGA (Field Programmable Gate Array) by using a commercial logical composition designing tool.

As set forth above, according to exemplary embodiments of the invention, an on-chip network topology consuming a minimum communication delay time and minimum communication energy between communication paths is automatically generated. The topology is designed such that function blocks requesting large amounts of communications are disposed to be close together in the network in consideration of communications patterns between the IP modules in the process of generating the on-chip network topology, to thus improve overall performance and minimize energy consumption and hardware.

In addition, a minimum solution of an upper node is obtained by utilizing that of a lower node, based on which node merging is performed to thus maximize the efficiency of the binary tree optimization process.

The results of comparing the on-chip network topology proposed by the present application with the conventional scheme shows that the communication performance of a maximum 30 percent and a reduction in communication energy of 27 percent were achieved.

While the present application has been shown and described in connection with the exemplary embodiments, it will be apparent to those skilled in the art that modifications and variations can be made without departing from the spirit and scope of the invention as defined by the appended claims.

What is claimed is:

1. A method of composing an on-chip network topology, the method comprising:
analyzing a communications pattern between IP modules and generate a traffic graph by performing SoC designing specification-implemented reference codes and generating a traffic graph;
generating a binary tree having the IP modules as the lowermost child nodes based on the traffic graph;
obtaining a minimum solution of each node while sequentially searching the binary tree in a direction from the lowermost nodes to the uppermost node, and if a search target node has child nodes, obtaining a minimum solution of the search target node by using the minimum solutions of the child nodes;
if the search target node is a root node, stopping the searching of the binary tree and merging the nodes of the binary tree according to the minimum solution of the search target node;
inserting an additional path for shortening communications time between nodes into the binary tree to optimize the binary tree; and
generating hardware having the optimized binary tree as an on-chip topology.

2. The method of claim 1, wherein the obtaining of the minimum solution of the search target node comprises:
sequentially searching the binary tree in the direction from the lowermost nodes to the uppermost node and checking whether or not the search target node has child nodes;
if the search target node does not have a child node, directly obtaining the minimum solution of the search target node; and
if the search target node has child nodes, obtaining the minimum solution of the search target node by using the minimum solutions of the child nodes.

3. The method of claim 2, wherein the directly obtaining of the minimum solution of the search target node obtains a solution set by applying all kinds of covering patterns, and then obtaining a solution with the lowest cost in the solution set, as the minimum solution of the search target node.

4. The method of claim 2, wherein the obtaining of the minimum solution of the search target node by using the minimum solutions of the child nodes obtains the minimum solution of the search target node, by merging the minimum solutions respectively obtained by the child nodes into the search target node while distributing the maximum number (K) of edges connectable to the search target node, as h (1>h>K−1) and K−h, to the child nodes.

5. A method for optimizing a binary tree, comprising:
sequentially searching a binary tree having IP modules of an on-chip network as the lowermost child nodes in a direction from the lowermost node to the uppermost node, and checking whether or not a search target node has child nodes;
if the search target node does not have a child node, directly obtaining a minimum solution of the search target node, while if the search target node has child nodes, obtaining the minimum solution of the search target node by using the minimum solutions of the child nodes; and
if the search target node is an intermediate node, continuously searching the binary tree, and if the search target node is a root node, optimizing the binary tree by merging nodes of the binary tree according to the minimum solution.

6. The method of claim 5, wherein the obtaining of the minimum solution of the search target node comprises:
if the search target node has no child node, obtaining the minimum solution of the search target node by applying all kinds of covering patterns; and
if the search target node has child nodes, merging the minimum solutions respectively obtained by the child nodes into the search target node while distributing the maximum number (K) of edges connectable to the search target node, as h (1≦h<K−1) and K−h, to the child nodes, to obtain the minimum solution of the search target node.
